(19) United States
(12) Patent Application Publication
(10) Pub. No.: US 2011/0225013 A1
(43) Pub. Date: Sep. 15, 2011

(54) CONFERENCE PRODUCTIVITY AND THICK CLIENT METHOD

(75) Inventors: David Chavez, Broomfield, CO (US); Jeffrey G. Gartner, Hopewell Junction, NY (US); Gerard O'Sullivan, Dublin (IE)

(73) Assignee: AVAYA INC, Basking Ridge, NJ (US)

(21) Appl. No.: 12/720,869

(22) Filed: Mar. 10, 2010

(51) Int. Cl. G06Q 10/00; H04M 3/42; G10L 15/26

(52) U.S. Cl. 705/7.18; 379/202.01; 704/235; 704/E15.043

(57) ABSTRACT

An automated, or semi-automated system that manages conference attendance to the parties who are really necessary based on, for example, one or more of participation and feedback during previous conference call(s) (and/or on a current call) and the ability to load a thick client for facilitating and coordinating non-verbal communications between conference participants. It could be advantageous for a conference participant to have the ability to indicate non-verbally their interest the conference, rather than disrupt the meeting, thus adding to productivity. It could also add to the utility if a conference coordinator or host could easily keep a record of why attendees drop from the conference, and intelligently apply this record to future scheduling. Another exemplary advantage is to set-up a pre-canned message and coordinate delivery of such messages about participation, interest, and/or status between two or more members (including the host) of the conference call.

### FIELD

An exemplary embodiment is directed toward conference communications. More specifically, an exemplary embodiment is directed toward an automated, or semi-automated system that limits conference attendance to the parties who are really necessary based on, for example, one or more of participation and feedback during previous conference call(s) (and/or on a current call) and the ability to load a thick client for facilitating and coordinating non-verbal communications between conference participants.

### BACKGROUND

Companies are typically faced with productivity issues. Often employees attend conference calls where they have minimal, if any, participation. Employers may have no idea that they have employees whose productivity is not optimal on these calls. When an employee attends a lot of meetings, meetings where they may not need to attend, and/or don't participate, leads to frustration on calls where there are employees that have a need to attend and have content to add.

Additionally, there could be challenges for the conference coordinator or host where they have trouble scheduling conferences due to conflicting calendar availability across the attendee list which contains people who are not really contributing to an ongoing discussion(s). The bottom-line is that it is well known that smaller meetings are easier to schedule, are more effective and take fewer resources.

### SUMMARY

However, it is currently incumbent on the host and participants to make scheduling decisions wisely and this is not always possible in advance of a conference. Where conferences are repetitive in nature and/or once a conference has begun, it is frequently possible to make better attendance decisions either in real-time or going forward. It could be advantageous for a conference participant to have the ability to indicate non-verbally why they are dropping from the conference to the host, rather than disrupt the meeting, thus adding to productivity. It could also add to the utility if a conference coordinator or host could easily keep a record of why attendees drop from the conference, and intelligently apply this record to future scheduling.

Another possible advantage is to set-up a pre-canned message, such as those defined below, and coordinate delivery of such messages about participation, interest, and/or status between two or more members (including the host) of the conference call. A problem with this currently is that participants may not have instant messaging capability, or another message facility to send such messages. Even if they do, it may require more negotiation to achieve particular results without centralized coordination. Such messaging facility could be via IM, SMS, or other generic facility and/or could be via a proprietary message capability offered by, for example, the bridge.

Another problem exists in that a certain amount of conference call time may be taken up by setting up sidebar discussions, related conference calls, splitting a large interest area into more efficient sub-topics, and the like. Coordination and facilitation of such negotiations without interrupting the call verbally could be advantageous and could be consistently possible via a thicker conferencing client.

Today, anyone with a direct conference invite or one that was forwarded to them can join a conference (unless settings on the initial bridge reservation limit the attendance). Additionally, a host can manually create the calendar invites and select the mandatory and optional attendees and is responsible, typically, for checking availability of the participants.

A participant of the conference may have a single important topic that they wish to contribute. In current conference calls, the participant would take conference time to announce this fact and the conference coordinator or host would typically request that such participant's topics be handled first so that they can leave. A more robust or intelligent client, such as a thick client, could allow negotiation and dynamic changes to meeting agendas to better deal with such disruptions.

Sidebar discussions via multiple media are known. However, conferencing products lack the ability to coordinate certain activities non-verbally, such as spawning related conferences, sub-conferences, ad-hoc sidebar discussions within a limited group, and many other activities.

Therefore, there are many typical conference activities that are disruptive to efficient time usage that could be solved via a conference client to coordinate and facilitate certain non-verbal activities. This conference client could be a feature-rich or an intelligent application which could be downloaded and installed, or in other cases, could be load at the beginning of a conference, such as a web conference.

There are two exemplary components to this method of improving efficiency. The first is the ability to dynamically alter conference participation and current and/or future conferences based on participant and/or host/participant input and sidebars. The second is the ability to move selected discussions, ones that are disruptive to the normal meeting flow, to a non-verbal communication facility that makes use of a thicker client to facility, coordinate, and report on decisions made via these non-verbal means.

One exemplary embodiment of the first component is the ability to monitor each participant's activity as an initial indication of their interest and/or engagement level in a particular conference. This could be enhanced with another component that allows each participant to indicate their interest in this particular conference via pre-canned or contemporaneous messages. These messages could be related to the entire conference or individual topics/speakers within the conference. While post conference messaging and surveys exists, they are not offered in a real-time, coordinated fashion that allows dynamic addition or deletion of participants with the concurrence of the host.

Examples of these pre-canned messages could fall into a variety of categories such as: early departure, priority interrupt, content different than expected, would like a copy of the recording, meeting minutes, action items, and the like. In general, any message related to feedback about the status of a participant and/or the conference/meeting could be utilized. If the additional component is expanded to allow survey of feedback of individual topics and speakers, pre-canned messages for those purposes could be added as well. Use of these real-time could allow the conference coordinator or host to more effectively manage meetings by taking action based on real-time feedback. Examples of the second type of pre-canned message could include, but are not limited to, ratings of speakers, ratings of topics, going off topic, going over time allotment, and the like. Beyond the pre-canned messages of each type described above, personalized input could also be useful and could contain comments, feedback, action items to be considered, and the like. Part of the debriefing of the conference could be post-conference dissemination of results. These could be in the form of conference recordings, action item lists, summaries or meeting minutes, and the like. Such implementation could be uniformly offered to all participants or be filtered by the interest designated by the participants.

Using both the activity and interest feedback monitors, the hosts, or department manager, etc, could actually get the listing of the contributors, the experts, the lurkers, etc. This information could be used when setting up the next call so that attendees that are providing little value are not invited or only treated as optional. This helps reduce the wasted time spent by people who are not really contributing to the call (or conference), and helps the host schedule follow-ups by minimizing time conflicts. This improvement also allows those who periodically miss a meeting to catch up without taking the host or another participant's time to ask what happened at the last meeting by subscribing to the recordings, action item lists, summaries, meeting minutes, or the like.

The second aspect allows signaling via a non-verbal communication mode between any two participants via a thick client. These non-verbal communications can avoid disruption of the normal meeting flow and allow real-time collaboration, problem solving, discussions, sidebars, proposals for sub-topics, or sidebar meetings, and the like. This signaling or messaging could also allow a pre-canned message set to effect certain frequent activities, but could also allow coordinated discussions via the client without having to assess whether all of those interested have IM (Instant Messaging) or some other messaging facility to participate. This facility could allow collaboration or problem solving usually reserved until after a meeting has ended, and therefore require additional time, to be done during the original meeting and potentially even present it to other participants if additional time is available.

While such IM communications can and do happen, they do not feature pre-canned messages, they are not coordinated in any way with the conference, and they do not typically allow selected sidebar via these messages without setting up such facilities in advance.

Another feature which helps streamline conference productivity is a push-to-talk feature implemented via the thick client. This push-to-talk feature allows a conference participant to break into a conference with the push-to-talk feature in essence acting like a reverse mute button. For example, if no one is speaking, the push-to-talk button allows a conference participant to speak. If another conference participant is speaking, the push-to-talk feature allows another participant to barge into the conversation. In another exemplary embodiment, the push-to-talk feature provides a notification to another conference participant, such as a moderator, and once this other conference participant grants permission, the requestor of the push-to-talk feature is allowed to speak. In yet another exemplary embodiment, the push-to-talk feature provides speech-to-text conversion, with the text being provided to one or more other conference participants and/or the moderator.

In accordance with another exemplary embodiment, a tool provides the ability to limit participation in conferences to those that really need to be there, based on, for example, past participation. Additionally, giving the host a way to schedule the calls using real-time data around those that actually need to be there versus the optional ones in a conference provides an additional productivity benefit that is yet unrealized. A thick client can be used for facilitating and coordinating non-verbal questions, inputs, statuses, and/or set-up of related conferences or sidebars. This can be further improved by use pre-canned messages within the client that are frequently used.

Accordingly, an exemplary embodiment is directed toward enhancing conference or meeting productivity.

Another exemplary aspect is directed toward facilitating inviting of one or more attendees.

Even further aspects are directed toward facilitating removal of one or more conference participants from a conference.

Even further aspects are directed toward monitoring of participant activity.

Additional aspects are directed toward monitoring of participant interest.

Even further aspects are directed toward monitoring of participant messaging.

Aspects are also directed toward monitoring requests for dynamic additions/deletion of participant(s).

Aspects are also directed toward monitoring feedback to one or more of the host and/or another participant.

Additional aspects relate to monitoring of sidebar discussions.

An additional aspect is directed toward monitoring for a push-to-talk request, and implementing the push-to-talk request, for example, based on one or more rules.

Additional aspects are directed toward one or more of calendar management, dynamic additions/deletion of participants, sidebar conversation initiation, logging, push-to-talk, polling, and messaging.

Even further aspects are directed toward a method for improving conference efficiency including monitoring, with the cooperation of an activity monitoring module, activities of one or more conference participants, determining, at least based on the monitoring, whether a conference participant should be included in future conferences, updating the conference participants calendar and notifying a conference host of the update.

These and other advantages will be apparent from the disclosure contained herein. The above-described embodiments and configurations are neither complete nor exhaustive. As will be appreciated, other embodiments of the invention are possible utilizing, alone or in combination, one or more of the features set forth above or described in detail below.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

### BRIEF DESCRIPTION OF THE DRAWINGS

FIG. 1 illustrates an exemplary conference environment;

FIG. 2 illustrates an exemplary time line of actions that occur during a conference;

FIG. 3 is a flow chart outlining thick-client operations;

FIG. 4 is a flow chart outlining in greater detail the calendar management portion of FIG. 3;

FIG. 5 is a flow chart outlining in greater detail the additions/deletion of participants from a conference in greater detail;

FIG. 6 is a flow chart outlining in greater detail a method for managing sidebar conversations; and

FIG. 7 is a flow chart outlining an exemplary method for the push-to-talk feature.

### DETAILED DESCRIPTION

Some embodiments will be illustrated below in conjunction with an exemplary communication system. Although well suited for use with, e.g., a system using a switch(es), server(s) and/or database(s), the embodiments are not limited to use with any particular type of communication system or configuration of system elements. Those skilled in the art will recognize that the disclosed techniques may be used in any communication application in which it is desirable to provide a temporary mailbox for a conference.

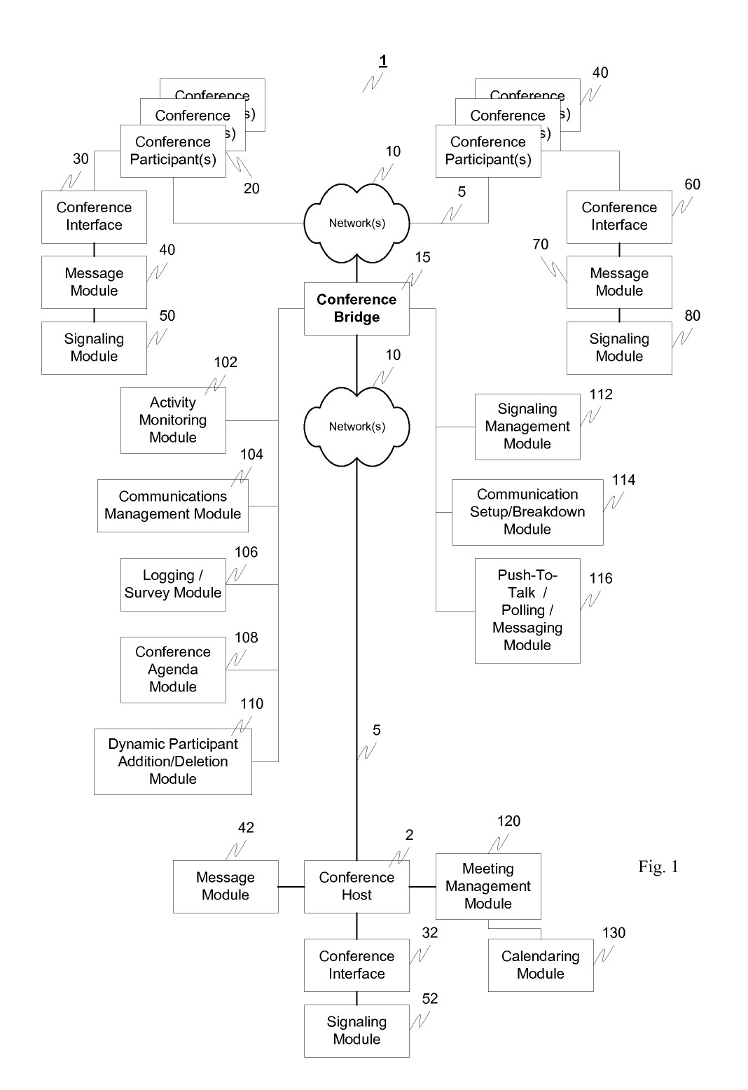

Referring initially to FIG. 1 an exemplary communication environment 1 will be described in accordance with at least some embodiments. The communication system comprises a communication network connecting a plurality of communication devices to a conference bridge.

In one embodiment, communication system may include a switch that may include a private branch exchange (PBX) system or any similar type of switching system capable of providing a telephone service to an enterprise associated with the switch. The switch may be one of a number of known exchange systems including, but not limited to, Private Automated Branch Exchange (PABX), Computerized Branch Exchange (CBX), Digital Branch Exchange (DBX), or Integrated Branch Exchange (IBX). The switch may also comprise a switching fabric that provides for the connection of multiple endpoints such as communication devices associated with the conference participants, servers, and databases. The switching fabric can provide the functionality to direct incoming and/or outgoing calls to various endpoints and further provides for conferencing capabilities between endpoints.

The communication devices associated with the participants may be packet-switched or circuit-switched and can include, for example, IP hardphones such as the Avaya Inc.'s, 4600 Series IP Phones™, IP softphones such as Avaya Inc.'s, IP Softphone™, Personal Digital Assistants or PDAs, Personal Computers or PCs, laptops, packet-based H.320 video phones and conferencing units, packet-based voice messaging and response units, packet-based traditional computer telephony adjuncts, and conventional wired or wireless telephones.

FIG. 1 outlines an exemplary embodiment of a communications environment 1. The communications environment 1 includes one or more conference participants 20 and 40, each with an endpoint and associated conference interface (30, 60) message module (40, 70) and signaling module (50, 80). In addition, the conference environment 1 includes a conference bridge 15, one or more networks 10, as well as an activity monitoring module 102, communications management module 104, logging/survey module 106, conference agenda module 108, dynamic participant addition/deletion module 110, signaling management module 112, communication setup/breakdown module 114, as well as the push-to-talk, polling, and messaging module 116. The conference environment further includes a conference host, with an associated message module 42, conference interface 32, signaling module 52, as well as a meeting management module 120, and calendaring module 130.

In general, one or more of the exemplary embodiments discussed herein facilitate conferencing between one or more conference participants, such as conference participants 20, 40, and a conference host 2. As is to be appreciated, each conference participant can have an associated conference interface, message module and signaling module, such as conference interface 30, message module 40, and signaling module 50 associated with conference participant 20. Similarly, the conference host 2 can have an associated message module 42, conference interface 32, signaling module 52, as well as be associated with a meeting a management module 120 and a calendaring module 130.

As discussed in greater detail hereinafter, one or more aspects are directed toward monitoring of participant activity, monitoring of participant interest, monitoring of participant messaging, the dynamic and/or automatic or semi-automatic addition or deletion of participants, monitoring feedback, monitoring sidebar discussions, monitoring push-to-talk requests, polling and/or messaging, and allowing for one or more of calendar management, and lurker monitoring.

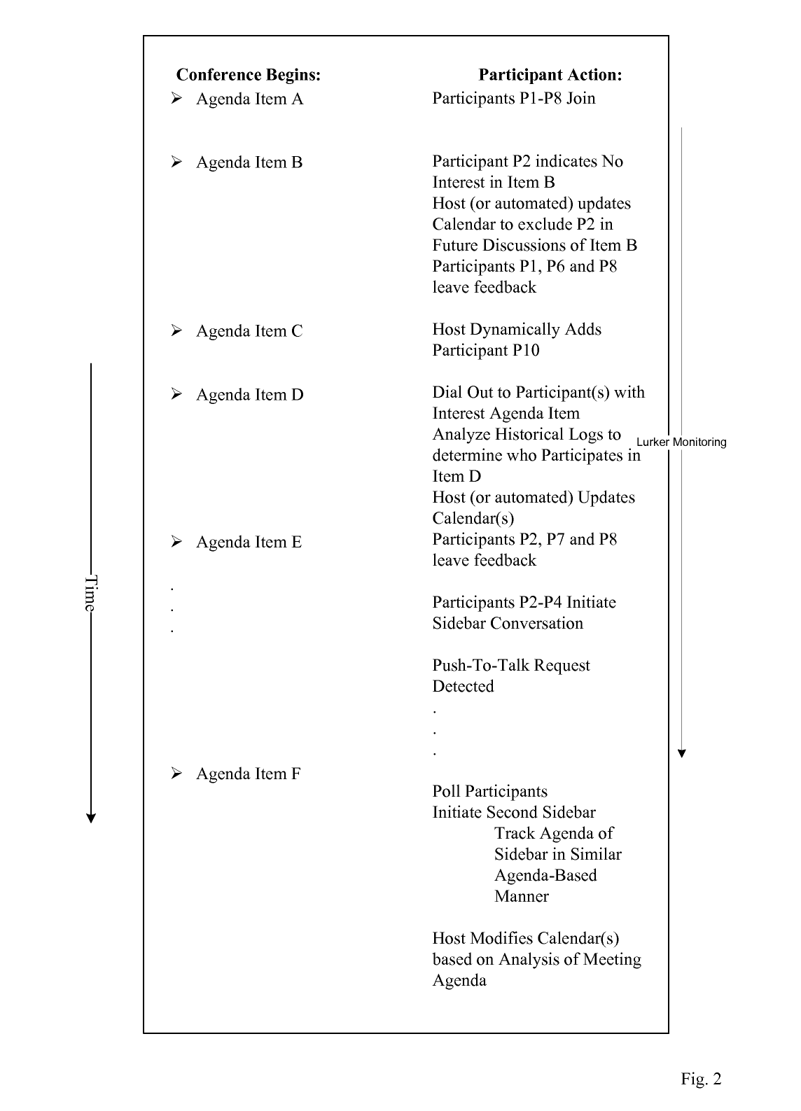

More specifically, a conference host 2, typically in cooperation with the conference interface 32, and conference bridge 15, initiate a conference. This conference can be between two or more conference participants, with each conference participant optionally provided with their own conference interface which provides one or more of messaging, signaling, and additional functionality as discussed hereinafter. In accordance with an exemplary embodiment, and as illustrated in exemplary FIG. 2, a conference can have a certain number of agenda items, with certain functionality of the conference being based on one or more of these agenda items.

For example, and in cooperation with the activity monitoring module 102, activities such as joining the conference, messaging or communications during the conference, and the like can be monitored, and optionally logged, in cooperation with the logging/serving module 106. More specifically, and in relation to an exemplary conference illustrated in FIG. 2, agenda item A is the first item that is being discussed in an exemplary conference. For that agenda item, participants P1-P8 join the conference, with this activity being monitored by the activity monitoring module 102. Additionally, the activity monitoring module 102 is capable of monitoring any one or more of participant interest, participant messaging, feedback, sidebar discussions, as well as allow interfacing with a calendar, with the cooperation of the meeting management module 120 and calendaring module 130.

Additionally, and in cooperation with the push-to-talk module 116, the activity monitoring module 102 detects a request and facilitates, with the cooperation of the conference bridge 15, the ability for a user to utilize the push-to-talk feature discussed herein.

The joining participants, such as participants P1-P8 as illustrated in FIG. 2, can be done in a traditional manner, for example, by the participants calling into the conference bridge 15 and joining the conference. Additionally, or alternatively, and in cooperating with the meeting management module 120, calendaring module 130, conference agenda module 108, and communications setup/breakdown module 114, one or more participants can also be automatically added to the conference, for example, when a particular agenda item is being discussed. For example, and in accordance with an exemplary embodiment, a conference attendee can indicate one or more particular agenda items that they are interested in, thus saving them from having to participate in portions of the conference that they may have little or no interest in, or otherwise possibly excluded from participation therein. As an example, when a conference invitation goes out, via for example an e-mail invitation, a conference participant can respond indicating their interested in one or more agenda items, or the entirety of the conference. This information can be saved in cooperation with the meeting management module 102 and calendaring module 130, such that when a particular agenda item is reached during the conference, the participant(s) that are interested in that agenda item can automatically be contacted to join the conference for that agenda item. As another example, a participant can indicate interest in the outcome of a conference or agenda item in a conference. The outcome could be a text transcript of that portion of the conference annotated with tags for of interest topic(s) in the body of the text.

Further in addition, a participant's activity can be monitored during a conference, and that activity used as the basis for determining whether a conference participant should be included in future conferences and/or agenda topics for discussion. Other options could be: 1) ask the host if they really want to include them since they are only lurking, or 2) simply copy them but don't use them as a basis for calendar scheduling. This can be combined with polling and/or messaging from the user, such that, for example, with the cooperation of the conference interface 30 and message module 40, one or more participants polled during a conference to indicate their interest level of one or more agenda topics. This information can then be used by the conference host 2, to assist with insuring the appropriate participants are included in future conference invitations.

More specifically, and in cooperation with the activity monitoring module 102, meeting management module 120, and calendaring module 130, a host such as conference host 2, can review participant participation, and a participant's calendar can be updated for future meetings. In a similar manner, new conferences can be added to the participant's calendar, with the cooperation of the calendaring module 130, such as when a user indicates they have no interest in a particular agenda item, but do have interest in another agenda item that may have, perhaps, come up during a sidebar conversation during the originally scheduled conference.

As discussed, participants can be added/deleted from the conference either automatically, semi-automatically, or, for example, at the direction of the conference host 2 or one or more of the conference participants. In accordance with a first exemplary embodiment, participants can be added to a conference manually if one of the participants indicates another participant should be included. Then, in cooperation with the communications setup/breakdown module 114, and the communications management module 104, a communication, such as a call (or multimedia session, or the like), can be initiated to the participant that is to be included. Should the participant answer the incoming communication, the participant can be provided with, for example, a conference interface, message module, and the like, similar to the other conference participants. In accordance with a second exemplary embodiment, a participant can be added dynamically such as when a particular agenda item is reached during an ongoing conference. For example, and as discussed in relation to agenda item D in FIG. 2, when agenda item D is reached, the communications setup/breakdown module 114, in cooperation with the conference agenda module 108 and communications management module 104 initiates a communication to the participant(s) that are interested in agenda item D—this dynamic action could also be coupled with approval of one or more conference participants and/or the host such that the addition/deletion is semiautomatic.

In accordance with another exemplary embodiment, and as can be seen in relation to agenda item C, the host dynamically adds participant P10 when agenda item C is discussed.

In a similar manner, one or more participants can be removed for a conference based one or more triggering activities or events. For example, and in accordance with the first exemplary embodiment, a host can manually remove a participant from the conference. In accordance with another exemplary embodiment, and say for example, in relation in FIG. 2 after participant P10 was dynamically added for agenda item C, the host, knowing that participant P10 should not be included for agenda item D, can notify the meeting management module 120 that participant P10 is to be removed from the conference, for all agenda items except for agenda item C. Thus, when agenda item D is reached, participant P10 is removed from the conference.

In cooperation with the activity monitoring module 102, the addition or deletion of participants from a conference can be capitalized upon, and that information used to assist with scheduling future invites and calendared conferences. For example, if participant 10 is to be included in all meetings that discuss agenda item C, the system can automatically, or, for example, upon the approval of the conference host, update the relevant calendars to include participant P10 for all future meetings that discuss agenda item C. A similar manner, if participant P10 is scheduled for future meetings that do not discuss agenda item C, that may include agenda items that the participant is not to be included for, the meeting management module 120, cooperating with a calendar module 130, can remove that calendared item from participant P10's calendar.

Keeping with the general theme of being able to monitor one or more of conference participants participation in a conference, and in cooperation with the communications management module 104 and activity monitoring module 102, sidebar conversations can be monitored. In addition, and in cooperation with the communications setup/breakdown module 114 and communications management module 104, one or more communications modalities can be initiated to support any one or more sidebar conversations between any one or more of the conference participants and the conference host. As with the other activities discussed herein, and in cooperation with the logging module 106, these sidebar conversations can be logged and recorded.

Another exemplary feature is the ability to use a push-to-talk function. More specifically, and in cooperation with a push-to-talk module 116, at any time during a conference a conference participant can request push-to-talk. Upon detection of this request by the push-to-talk module 116, one or more actions can occur. First, the push-to-talk request can allow any participant to automatically break into a conference and begin speaking Two, if no one is speaking, the requestor of the push-to-talk request can be allowed in the conference and begin speaking. Three, even if someone is speaking, the push-to-talk request allows an immediate barge into a conference. Four, the detection of the request can notify the moderator of the request, who can determine how to handle the request. Five, one or more rules can be established that have associated permissions that govern how the push-to-talk request is to be handled. For example, if it is the moderator of the meeting, the moderator may be automatically allowed to break into the conference. Alternatively, if it is determined that the requestor is a conference participant who has participated, perhaps a notification can go to the moderator who can choose whether or not to immediately allow the requestor to barge into the conference. Six, in another exemplary embodiment, the push-to-talk request triggers a speech-to-text converter that converts a message from the requestor, with this message then being communicated to one or more conference participants with the cooperation of the communications management module 104. For example, this message can be communicated and displayed with the cooperation of the message module 40 and one or more conference participant's conference interfaces.

In FIG. 2, and parsing the page from top to bottom as time passes, various agenda items are displayed that include a corresponding participant action. More specifically, for agenda item A, participants P1-P8 join. For agenda item B, participant P2 indicates there's no interest in item B. Based on this received input, the host, or in an alternative embodiment, the meeting management module 120 cooperating with the calendaring module 130, updates the participant's calendar and future meeting invites to exclude participant P2 in future discussions of agenda item B. Furthermore, participants P1, P6, and P8 leave feedback for agenda item B that is detected by the activity monitoring module 102 and recorded by the logging/survey module 106. For agenda item C, the host dynamically adds participant P10, with the cooperation of the communication setup/breakdown module 114 and dynamic participant addition/deletion module 110. For agenda item D, the system automatically dials out to one or more participants that have an interest in the agenda item. In addition, an analysis is performed on prior conferences that discuss agenda item D, who participates in discussing agenda item D. This information can be used, for example, to update calendars, determine whether an agenda item D needs to be in future conferences, or the like. Based on this determination, one or more of the host or the system can update one or more of the calendars associated with agenda item D.

For agenda item E, participants P2, P7, and P8 leave feedback. Participants P2-P4 also initiate a sidebar conversation that is logged, and at some point during the discussion of agenda item E, a push-to-talk request is detected, and handled in accordance with the discussion above. For agenda item F, and in cooperation with polling module 116, a poll is sent out to one or more participants that asks for their feedback on one or more of the agenda item, other agenda items, or the entire conference. In addition, a second sidebar conversation is initiated, where the agenda of the sidebar can be tracked in a similar agenda-based manner. Then, based on the analysis of the meeting, one or more of the host and the system can modify future calendars and meeting invitations based on the analysis.

In addition to the above, as indicated on the right hand side of FIG. 2, lurker monitoring can be initiated for any one or more of the agenda items during the conference. This lurker monitoring, in cooperation with the activity monitoring module 102, looks for conference participants that do not contribute to the conference (or do not meet some minimal participation metric). Then, in cooperation with the logging module 106, this information can be provided to, for example, the conference host, who can decide whether or not to include that participant(s) in future conferences. As an option, once a lurker is detected, a communication can be prepared for the conference host to the identified lurker to assist with asking the lurker if they should be included in future meetings.

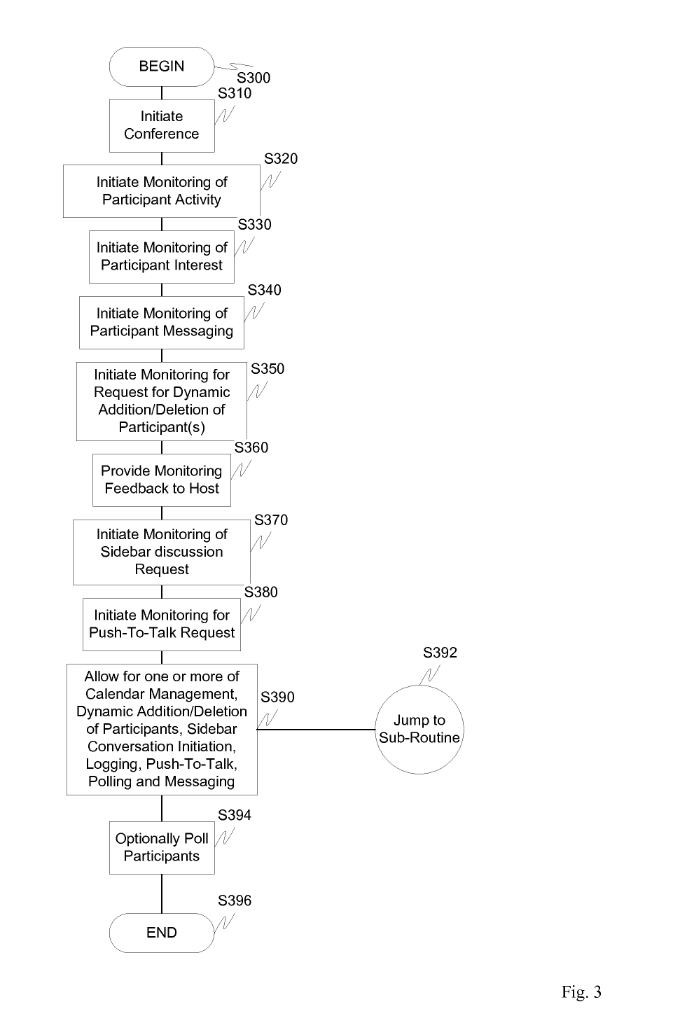

FIG. 3 outlines an exemplary method of some of the techniques that can be used for the system discussed herein. In particular, control begins in step S300 and continues to step S310. In step S310, a conference is initiated. Next, in step S320, monitoring of participant activity can optionally be initiated. Then, in step S330, monitoring of participant interest can optionally be initiated. Control then continues to step S340.

In step S340, monitoring of participant messaging can optionally be initiated. Next, in step S350, the monitoring for a request for the dynamic addition or deletion of one or more participants can optionally be initiated. Then, in step S360, feedback based on the monitoring can optionally be provided to, for example, the conference host. Control then continues to step S370.

In step S370, monitoring of sidebar discussions can optionally be initiated. Next, in step S380, monitoring for a push-to-talk request can optionally be initiated. Then, in step S390, one or more of calendar management, dynamic addition, dynamic deletion of participants, sidebar conversation initiation, logging, push-to-talk, polling, and messaging can commence. If any one of these occurs, control jumps to S392. Otherwise, control continues to step S394 where one or more participants can optionally be polled. Control then continues to step S396 where the control sequence ends.

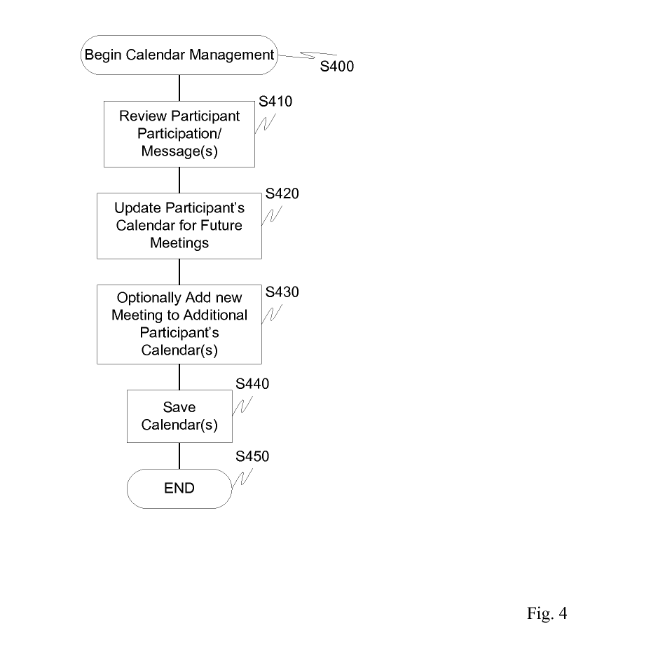

FIG. 4 illustrates an exemplary method calendar management. In particular, control begins in step S400 and continues to step S410. In step S410, one or more of participant's participation, participant messages, participant sidebar conversations, and the like, can be reviewed. Next, in step S420, one or more participant's calendars can be updated based on the review in step S410. Then, in step 430, one or more additional conferences can optionally be added to one or more participants calendars, based on the review in step S410. Then, in step S440, the one or more calendars are saved with control continuing to step S450 where the control sequence ends.

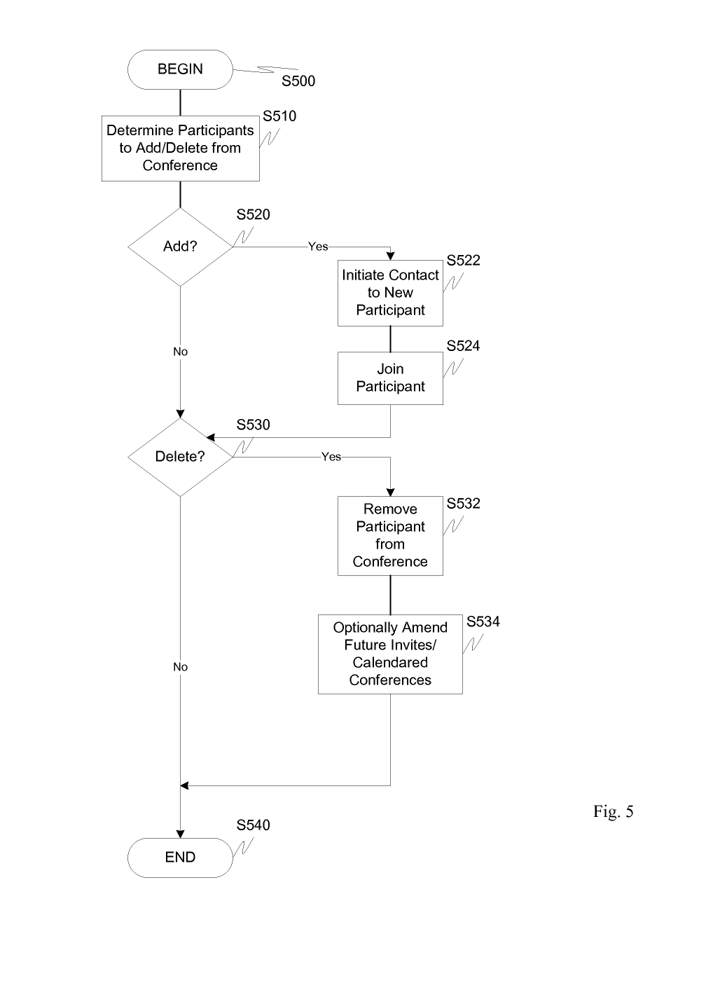

FIG. 5 outlines an exemplary method for the addition or deletion of one or more conference participants. In particular, control begins in step S500 and continues to step S510. In step S510, one or more participants can be added, or deleted, from a conference. As discussed, this can occur automatically, semi-automatically, or manually, for example based on the request of the host and/or one or more other conference participants. Next, in step S520, a determination is made whether one or more conference participants should be added to the conference. If one or more conference participants are to be added, control continues to step S522 with control otherwise jumping to step S530.

In step S522, a contact is initiated to a new participant. Then, in step S524, the participant joins the conference. Control then continues to step S530.

In step S530, a determination is made whether one or more participants are to be deleted from a conference. If one or more participants are to be deleted, control continues to step S532 with control otherwise jumping to step S540 where the control sequence ends.

In step S532, one or more participants can be removed from the conference. Next, in step S534, and optionally, future invitations and/or calendar events can be optionally amended based on the removal of this conference participant from the conference. Control then continues to step S540 where the control sequence ends.

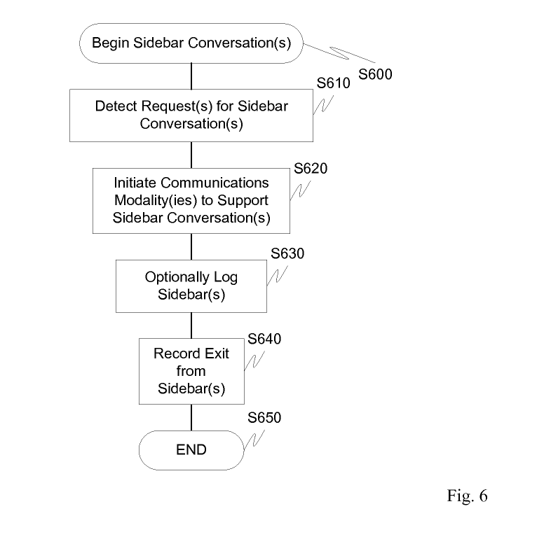

FIG. 6 outlines and exemplary method for managing sidebar conversations. In particular, control begins in step S600 and continues to step S610. In step S610, one or more requests for one or more sidebar conversations are detected. Next, step S620, one or more communications modalities to support the one or more requested sidebar conversations are initiated. These can include, for example, chat sessions, messaging sessions, whiteboard sessions, verbal sidebar communications, or in general, any communications modality to support one or more sidebar conversations. Control then continues to step S630.

In step S630, the one or more sidebar conversations can optionally be logged. Next, in step S640, the exist from one or more sidebars can be recorded, for example, indicating when participant leaves the sidebar conversation, with control continuing to step S650 where the control sequence ends.

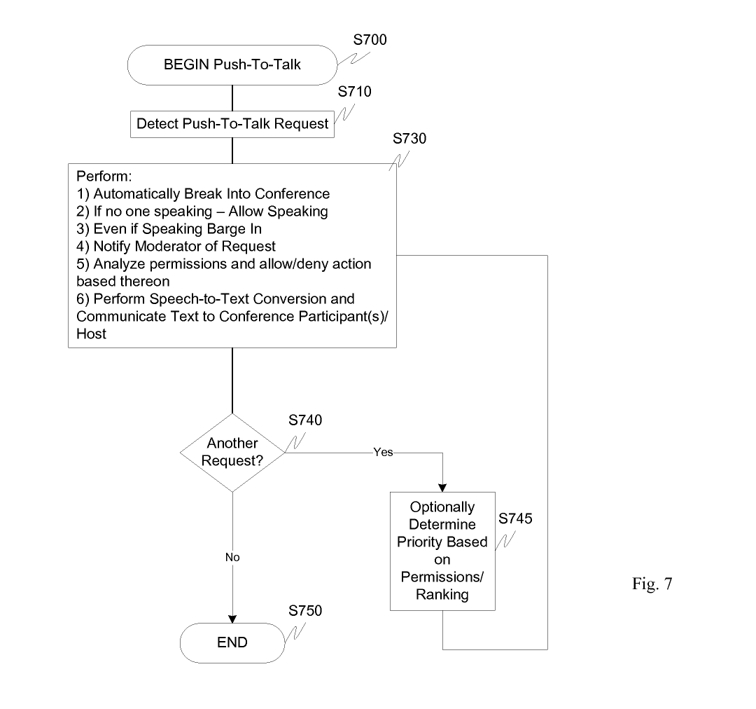

FIG. 7 outlines an exemplary method for push-to-talk. In particular, control begins in step S700 and continues to step S710. In step S710, a push-to-talk request is detected. Next, in step S730, one or more of the following are performed based on the push-to-talk request:

Automatically breaking into the conference;

If no one is speaking allow speaking, even if others are speaking, allow the requestor to barge in;

A notification to the moderator of the push-to-talk request;

An analysis of one or more permissions and/or rules, and based on the analysis, the requestor is allowed to, or denied to, speak; and

Perform one or more speech-to-text conversion and voice recording, and allow this communication to be communicated to one or more of the other conference participants and/or the host.

Control then continues to step S740.

In step S740, a determination is made whether another push-to-talk request has been made. If another push-to-talk request has been made, control continues to step S745 with control otherwise continuing to step S750 where the control sequence ends.

In step S745, and in the instance where there are multiple push-to-talk requests, an optional priority can be determined based on, for example, one or more rules or permissions that reconcile how parallel push-to-talk requests are to be handled. Control then jumps back to step S730.

The various embodiments include components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

While the above-described flowchart has been discussed in relation to a particular sequence of events, it should be appreciated that changes to this sequence can occur without materially effecting the operation of the invention. Specifically, a device can address a third party without leaving an existing communication session as long as signaling and addressing occurs outside the conference channel. Additionally, the exact sequence of events need not occur as set forth in the exemplary embodiments. The exemplary techniques illustrated herein are not limited to the specifically illustrated embodiments but can also be utilized with the other exemplary embodiments and each described feature is individually and separately claimable.

The systems, methods and protocols described herein can be implemented on a special purpose computer in addition to or in place of the described communication equipment, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a communications device, such as a phone, any comparable means, or the like. In general, any device capable of implementing a state machine that is in turn capable of implementing the methodology illustrated herein can be used to implement the various communication methods, protocols and techniques according to this invention.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and communication arts.

Moreover, the disclosed methods may be readily implemented in software that can be stored on a storage medium, executed on a programmed general-purpose computer with the cooperation of a controller and memory, a special purpose computer, a microprocessor, or the like. In these instances, the systems and methods of this invention can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications device or system.

It is therefore apparent that there has been provided, in accordance with the present invention, systems, apparatuses and methods for conference call management. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

1. A method for improving conference efficiency comprising:
monitoring, with the cooperation of an activity monitoring module, activities of one or more conference participants;
determining, at least based on the monitoring, whether a conference participant should be included in future conferences;
updating the conference participants calendar; and
notifying a conference host of the update.

2. The method of claim 1, further comprising dynamically adding one or more conference participants for one or more agenda items.

3. The method of claim 1, further comprising polling the one or more conference participants for feedback on the conference, and updating the determining step.

4. The method of claim 1, further comprising dynamically removing one or more participants from participating in one or more agenda items.

5. The method of claim 1, further comprising initiating monitoring of one or more sidebar discussions, wherein monitored sidebar discussion information is also used in the determining step.

6. The method of claim 1, further comprising detecting a push-to-talk request.

7. The method of claim 6, wherein the push-to-talk request results in one or more of:
an automatic breaking into the conference;
if no one is speaking:
allowing a push-to-talk requestor to speak,
if others are speaking:
allowing the push-to-talk requestor to speak;
sending a notification to a host of the push-to-talk request;
performing an analysis of one or more permissions and rules, and based on the analysis, allowing or denying the push-to-talk requestor to speak; and
performing one or more of speech-to-text conversion and voice recording, and forwarding this information to one or more of other conference participants and the host.

8. The method of claim 7, further comprising determining a priority of the push-to-talk requestor.

9. One or more means for performing the steps of claim 1.

10. A computer-readable non-transitory tangible storage media, having instructions stored thereon, that when executed by a processor, perform the steps of claim 1.

11. A system that improves conference efficiency comprising:
an activity monitoring module that monitors activities of one or more conference participants;
a meeting management module that determines, at least based on the monitoring, whether a conference participant should be included in future conferences;
a calendaring module that updates the conference participants calendar; and
a message module that notifies a conference host of the update.

12. The system of claim 11, further comprising a dynamic participant addition module that dynamically adds one or more conference participants for one or more agenda items.

13. The system of claim 11, further comprising a polling module that polls the one or more conference participants for feedback on the conference, and updating the determining step.

14. The system of claim 11, further comprising a dynamic participant deletion module that dynamically removes one or more participants from participating in one or more agenda items.

15. The system of claim 11, wherein one or more sidebar discussions are monitored, wherein monitored sidebar discussion information is also used by the meeting management module.

16. The system of claim 11, further comprising a push-to-talk module that detects a push-to-talk request.

17. The system of claim 16, wherein the push-to-talk request results in one or more of:
an automatic breaking into the conference;
if no one is speaking:
allowing a push-to-talk requestor to speak,
if others are speaking:
allowing the push-to-talk requestor to speak;
sending a notification to a host of the push-to-talk request;
performing an analysis of one or more permissions and rules, and based on the analysis, allowing or denying the push-to-talk requestor to speak; and
performing one or more of speech-to-text conversion and voice recording, and forwarding this information to one or more of other conference participants and the host.

18. The system of claim 17, wherein a priority of the push-to-talk requestor is determined.

19. The system of claim 11, further comprising a conference agenda module that tracks one or more agenda items during the conference.

20. The system of claim 11, wherein the modules are included in a robust or intelligent client, the client allowing negotiation and dynamic changes to meeting agendas and calendars, the client being a feature-rich or an intelligent software application that is capable of being downloaded and installed, the client being loaded at the beginning of the conference.
